(19) United States
(12) Patent Application Publication
(10) Pub. No.: US 2008/0172244 A1
(43) Pub. Date: Jul. 17, 2008

(54) Systems And Methods For Displaying Current Prices, Including Hotel Room Rental Rates, With Markers Simultaneously On A Map

(75) Inventors: Dustin Coupal, Regina (CA); Jason Donald Toews, Regina (CA)

Correspondence Address: HOLLAND & HART, LLP, P.O BOX 8749, DENVER, CO, 80201, US

(73) Assignee: GB Internet Solutions, Inc., Regina (CA)

(21) Appl. No.: 11/760,639

(22) Filed: Jun. 8, 2007

Related U.S. Application Data
(60) Provisional application No. 60/885,181, filed on Jan. 16, 2007.

(51) Int. Cl. G06Q 99/00; G06F 17/30

(52) U.S. Cl. 705/1

(57) ABSTRACT

There is disclosed systems and methods for displaying current prices of goods or services provided at a plurality of locations within a geographical area. In an embodiment, a system includes a computer terminal, a map server, an information source, a set of map markers, and a web server. In another embodiment, a method includes specifying the geographical area by an input of data, providing a map of the geographical area to a computer terminal, sending a query to an information source, matching map markers indicating specific prices to the current prices for selected ones goods or services, and relaying the map markers to the computer terminal, and overlaying the map markers onto the map so as to display current prices simultaneously for each of the plurality of locations. Other embodiments are also disclosed.

### REFERENCE TO PENDING PRIOR PATENT APPLICATION

This patent application claims benefit of pending prior U.S. Provisional Patent Application Ser. No. 60/885,181, filed Jan. 16, 2007 by Dustin Coupal and Jason Donald Towes for METHOD OF DISPLAYING HOTEL ROOM RENTAL RATE MARKERS DIRECTLY ON A MAP, which patent application is hereby incorporated herein by reference.

### BACKGROUND

Map markers have been in use for years. Typically, map markers are used in various mapping systems, by various map providers, and in mapping software that display maps and portions of maps based on user selected input. State of the art maps display various goods and services, such as local area hotels, movie theatres, and gasoline stations. These maps are typically used by consumers to find desired goods and services, such as a hotel room to rent, movie tickets to purchase, and gasoline for fueling. With currently used technologies for hotel identification and selection, the location of the local hotels are indicated on the map using a system of symbols, icons or markers, and no hotel price information is visible on the map unless the user performs further selection of a hotel location through use of a mouse, or other input device.

One problem with conventional map markers is that prior art maps use symbols, icons or markers to identify hotels, and these markers are simply location markers. No additional information is readily indicated with regard to the hotel and, in particular, the price or the hotel room rental rate is not indicated.

As shown on map 100 (FIG. 1), often markers 105 are completely generic and are identical in appearance for marking each of the hotels. As illustrated on map 200 (FIG. 2), some hotel markers 205A-205F may be unique to each hotel or to a particular group of hotels, e.g., specific brands of hotels. However, no currently available map markers incorporate pricing information of a room rental rate.

Another problem with conventional map markers is that prior art maps generally require users to interact with the hotel location marker in order to display the price of a room rental rate. This interaction typically requires a user to hover a pointer over the map marker using a computer mouse or to click the map marker using the computer mouse. Some maps may also use another selector, such as the keyboard, to choose a particular hotel so as to find the room rental rate presently available at that hotel. Such user interaction typically displays the room rental rate information for the hotel on the map in a “pop-up” balloon, a table or by other temporary display so as to show a current rate. Consumers trying to make decisions are thereby forced to undertake time consuming steps to click or otherwise select various hotels on the map so as to identify each of the hotel rates.

Other map products may include a list of hotel room rental rates in a separate table or box displayed adjacent to the viewable map. These products generally force the user to coordinate each hotel room rental rate as listed in the table with the marker or symbol location on the map.

While prior art map marker methods may be suitable for some particular purposes, the current markers are generally not suitable for indicating the current price of a hotel room rental rate at a certain hotel directly on a computerized map without requiring user interaction to view the price at any particular hotel location shown on the map.

### SUMMARY OF THE INVENTION

In an embodiment, there is provided a system for displaying current prices of selected ones of goods and services provided at a plurality of locations within a geographical area, the system comprising a computer terminal for specifying the geographical area containing the plurality of locations, and for displaying a map with the current prices of the selected ones of goods and services provided at the plurality of locations; a map server for providing a map image including the geographical area containing the plurality of locations specified with the terminal; an information source for providing data including the current prices of selected ones of goods and services provided at the plurality of locations specified with the computer terminal; a set of map markers for selected display on the map image provided by the map server, each one of the map markers having at least one alphanumeric character to represent a specific price; and a web server for relaying the map markers to the computer terminal, and overlaying the map markers onto the map at proper ones of the particular locations so as to display each of the current prices simultaneously on the map for each of the plurality of locations.

In another embodiment, there is provided a system for displaying current prices of selected ones of goods and services provided at a plurality of locations within a geographical area, the system comprising a computer terminal for specifying the geographical area containing the plurality of locations, and for displaying a map with the current prices of the selected ones of goods and services provided at the plurality of locations; a map server for providing a map image including the geographical area containing the plurality of locations specified with the terminal; an information source for providing data including the current prices of selected ones of goods and services provided at the plurality of locations specified with the computer terminal; a set of map markers for selected display on the map image provided by the map server, each one of the map markers having at least one alphanumeric character to represent a specific price; and a web server for relaying the map markers to the map server, embedding the map markers onto the map at proper ones of the particular locations so as to display each of the current prices simultaneously on the map for each of the plurality of locations, and relaying the map to the user terminal.

In yet another embodiment, there is provided a system for displaying current prices of selected ones of goods and services provided at a plurality of locations within a geographical area, the system comprising a computer terminal for specifying the geographical area containing the plurality of locations, and for displaying a map with the current prices of the selected ones of goods and services provided at the plurality of locations; a map server for providing a map image including the geographical area containing the plurality of locations specified with the terminal; an information source for providing data including the current prices of selected ones of goods and services provided at the plurality of locations specified with the computer terminal; a set of map markers for selected display on the map image provided by the map server, each one of the map markers having at least one alphanumeric character to represent a specific price; and a web server for relaying the map markers to the web server, overlaying the map markers onto the map at proper ones of the particular locations so as to display each of the current prices simultaneously on the map for each of the plurality of locations, and relaying the map to a computer terminal.

In still another embodiment, there is provided a method of displaying current prices of selected ones of goods and services provided at a plurality of locations within a geographic area, the method comprising specifying the geographical area by an input of data; providing a map of the geographical area to a computer terminal based on the input of data; sending a query to an information source to retrieve location and pricing information for a plurality of the selected ones of goods and services within the geographical area; matching map markers indicating specific prices to the current prices for each of the selected ones of goods and services using the location and pricing information so as to indicate the current prices at particular locations on the map; and relaying the map markers to the computer terminal, and overlaying the map markers onto the map at proper ones of the particular locations so as to display each of the current prices simultaneously on the map for each of the plurality of locations.

In another embodiment, there is provided a method of displaying current prices of selected ones of goods and services provided at a plurality of locations within a geographic area, the method comprising specifying the geographical area by an input of data; providing a map of the geographical area to a web server based on the input of data; sending a query to an information source to retrieve location and pricing information for a plurality of the selected ones of the goods and services within the geographical area; matching map markers indicating specific prices to the current prices for each of the selected ones of goods and services using the location and pricing information so as to indicate the current prices at particular locations on the map; and relaying the map markers to the map server, embedding the map markers onto the map at proper ones of the particular locations so as to display each of the current prices simultaneously on the map for each of the plurality of locations, and relaying the map to the user terminal.

In another embodiment, there is provided a method of displaying current prices of selected ones of goods and services provided at a plurality of locations within a geographic area, the method comprising specifying the geographical area by an input of data; providing a map of the geographical area to a web server based on the input of data; sending a query to an information source to retrieve location and pricing information for a plurality of hotels within the geographical area; matching map markers indicating specific prices to current prices for each of the selected ones of goods and services using the location and pricing information so as to indicate the current prices at particular locations on the map; and relaying the map markers to the web server, overlaying the map markers onto the map at proper ones of the particular locations so as to display each of the current prices simultaneously on the map for each of the plurality of locations, and relaying the map to a computer terminal.

Other embodiments are also disclosed.

### BRIEF DESCRIPTION OF THE DRAWINGS

Illustrative embodiments of the invention are illustrated in the drawings, in which:

FIG. 1 illustrates a prior art map showing generic map markers;

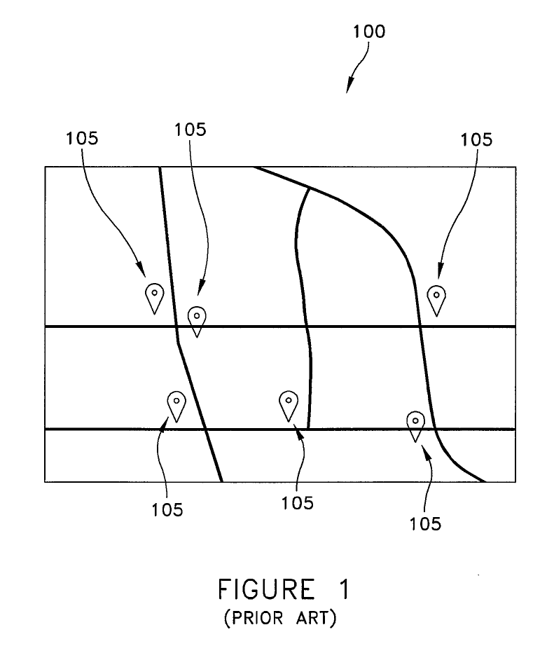

FIG. 2 illustrates a prior art map showing unique information markers without price information;

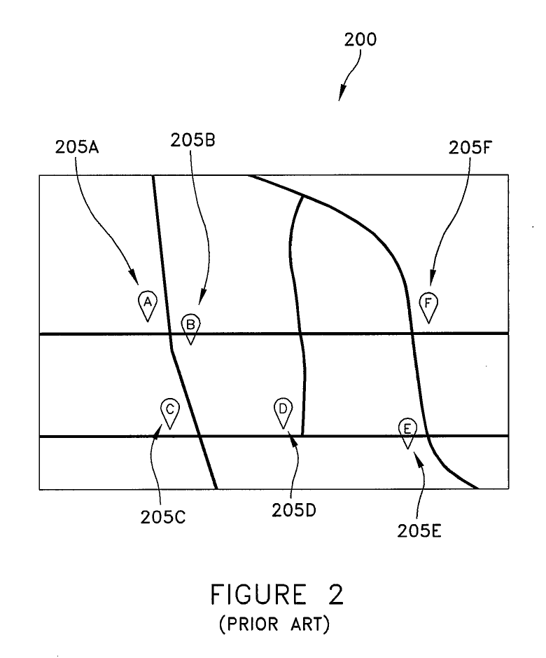

FIG. 3 illustrates a map display having map markers indicating current prices for several hotel locations, with an exploded view of one of the map markers;

FIG. 4 illustrates a map display having map markers indicating current prices and names for several hotel locations, with an exploded view of one of the map markers;

FIG. 5 is a diagram of an exemplary system for displaying current prices of hotel room rates at a plurality of locations within a geographical area, and maps are served through a map server separate from a web server;

FIG. 6 is a diagram of an exemplary system for displaying current prices of hotel room rates at a plurality of locations within a geographical area, and map markers may be incorporated directly into maps as provided by a map server;

FIG. 7 is a diagram of an exemplary system for displaying current prices of hotel room rates at a plurality of locations within a geographical area, and a static map is used as the map source;

FIG. 8 is a flowchart of an exemplary method of displaying current prices for goods or services provided at a plurality of locations within a geographic area; and

FIG. 9 illustrates a map display having map markers indicating current prices for several hotel locations.

### DETAILED DESCRIPTION

Systems and methods of displaying hotel room rental rate markers on a map are provided. The systems and methods may include an end-user computer with a display, which may be referred to as a terminal. The end-user computer may interact with a source of maps, i.e., a map server. A database of updated information is accessed regarding particular current hotel room rental rates. One or more web servers may be provided to dynamically select or generate appropriate hotel markers to display of the price of the room rental rate for a particular hotel location directly on the map.

A terminal is descriptive of an end user's computer. A terminal in its simplest form is a computer composed of a processor, storage and display. A terminal is a computer with the capability to both take user input and output the results on a display.

A terminal may take many different physical forms. The terminal may be a stationary unit such as a desktop computer but may also include hand-held devices, portable computing devices or devices mounted or built into automobiles. The terminal may have a built in Global Positioning System (GPS) receiver or other incorporated positioning system which would be used in the map generation/retrieval process of the current invention to identify locations on a digital map based on, for example, satellite data. GPS receivers are known to those skilled in the art. In one embodiment, the computer could be a desktop model and a direct Internet connection in which the user may access map views showing the price of a nightly hotel room rental rate in an area of interest. In another embodiment, the computer may be a smaller computerized display that is incorporated into the dashboard of an automobile where the user could view maps that show the price of a room rental rate in their local area. The computer may have a direct Internet connection or may be connected to the Internet by a wireless or satellite connection.

A map server may include a computer with a computer processor and storage with programming instructions for generating, storing or retrieving maps. Commonly, a map server is a dedicated type of web server. However, the process of performing as a map server, through programming instructions, may be performed on any computer with such physical capabilities to act as a web server, user terminal or database server. The map server may be a computer programmed to either deliver previously generated and stored maps or to generate maps for user terminals with a visual way to identify a particular geographic location. A map server may act as a source of map images to be delivered to either a web server, end user terminal or other computer once a request has been made for a particular map.

In an embodiment, a map server may generate the requested maps on an “as needed” basis from a source of geocoordinate information for various geographical features in a particular area. In another embodiment, a map server may have access to a collection of previously generated map files for delivery to fulfill a request. Previously generated map files may be located on the physical computer. Alternatively, the map server may connect to previously generated map files using a remote connection to another network computer or any computer accessible by the Internet where these map files are stored. The maps may be provided through a third-party or commercially available map server source such that the person or company operating the web server does not need to be the map provider. This may be the case if the map source is supplied by a web-accessible map server program, such as those provided by MapQuest or Google.

The maps produced by the map server are typically graphical representations that show geographic features such as roadways, roadway names, city names, parks, etc. The maps may be used to recognize and navigate to particular points of interest identified on the map by a map marker. Maps produced by the map server may be of various styles or shapes and may be delivered to the requesting computer or terminal in various different styles including computer generated images, graphic files, satellite photographs or aerial photographs. Maps may be zoomable, movable or otherwise user definable.

In an embodiment, the information source may include details on various pieces of information regarding each of the specific hotels to be displayed on the map. The information may include a price for a hotel room rental rate for a particular date (or dates) and the geographical location information for that hotel Typically the information includes a more complete set of hotel location specific details including but not limited to: (1) brand name and logo; (2) addressor geocoordinate information; (3) room availability by date; (4) information on various room types (king bed, suite and etc.); (4) room rental prices by date; (5) hotel amenities (pool, spa, restaurant, etc.) (6) images or photographs related to the hotel; (7) contact information; (8) other hotel details such as comments or descriptive information. The information is used to identify the proper location for a hotel on the map along with the price of the hotel at that location. The information also may include a collection of other data that may be of interest to map user. This type of hotel information may be provided through data feeds, which may include, but are not limited to, feeds from hotel corporations or travel service companies. Examples of sources for the information include companies operating under names such as Travelocity.com, Priceline.com, or Best Western International Inc. The information is typically retrieved through an Internet or network request multiple times per day or only on demand from the web server or user terminal (i.e., in real-time) from the information sources as noted above. This results in the most currently available hotel room rental rates being displayed on the map. The information may be stored on a storage unit accessible by the web server or user terminal in a format such as a database, XML or a flat file. A flat file may include a collection of records and fields often delimited by tabs, whitespace or commas.

The desired information required may include a hotel room rental rate for a particular date (or dates) and the location information for the hotel. Typically, the desired information may include a more complete set of hotel location specific details including, but not limited to: (1) brand name and logo; (2) address or geocoordinate information; (3) room availability by date; (4) information on various room types (e.g., king bed, suite and etc.); (4) room rental prices by date; (5) hotel amenities (e.g., pool, spa, restaurant, etc.); (6) images or photographs related to the hotel; (7) contact information; and (8) other hotel details such as comments or descriptive information. Map markers may be used to display the room rental rate (i.e., price) at a particular hotel location and may be composed of a series of letters or numbers (i.e., alphanumeric characters) that identifier the price of the room rental rate at the location. Often, the term map marker may be used interchangeably with the term map icon or map symbol by those familiar with the art. Pricing characters included as part of the map marker may be in the form of text characters or an image file.

The map markers are used to display the room rental rate (i.e., price) at a particular hotel location and include a series of characters or numbers that identifies the price of the room rental rate at that location. Often the term map marker is used interchangeably with the term map icon or map symbol by those familiar with the art. The pricing characters included as part of the map marker may be in the form of text characters or an image file. The purpose of the markers is to indicate to the end user the location and price of a hotel room rental rate. Map markers may include image files to be overlaid onto the image of the map by the user's terminal. The map markers, alternatively, may include text characters that are dynamically generated or selected based on the hotel rental rate information.

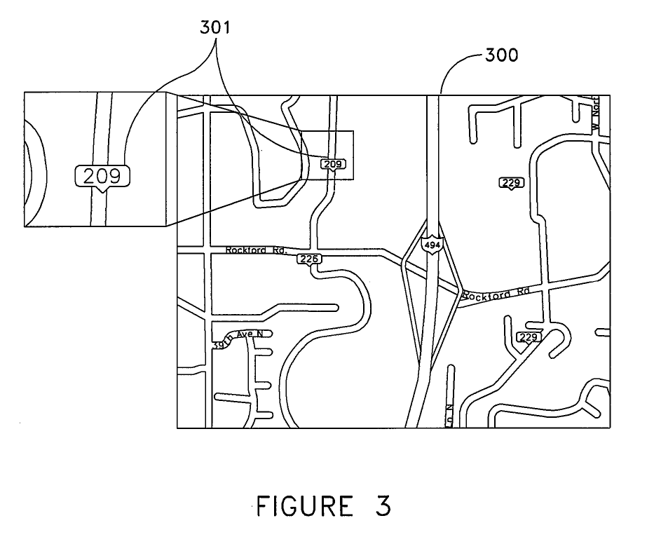

Looking at FIG. 3, there is shown a map 300 with an example of a marker 301. The marker 301 represents a hotel location where the room rental rate is $209.00. Markers may take various shapes, styles and size, but each is an indicator to state the particular price of a room rental rate directly on the map. Markers may be made in various shapes, colors or sizes, but each one states the particular price of a room rental rate directly on the map.

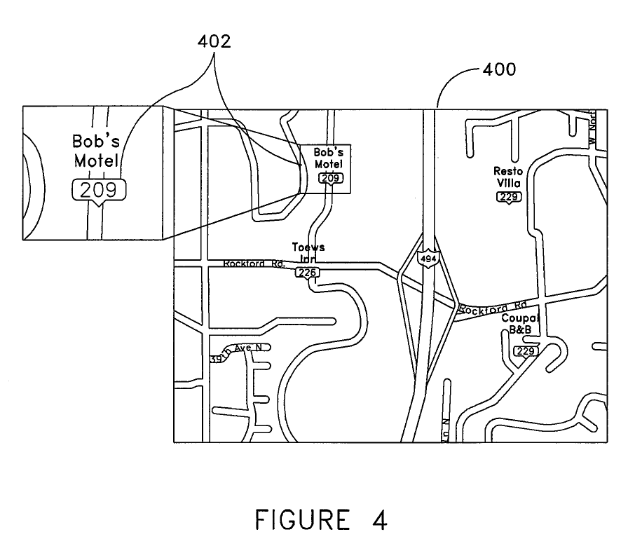

Referring now to FIG. 4, there is shown a map 400 with an example of another marker 302 with other information in addition to the price of the hotel. This information may include hotel name, star level, or other information for users of the map. Once the map markers are shown on a user's terminal, the markers may be programmed for selection by a user. This selection may be made, for example, through the use of a device such a mouse, trackball, joystick or touch screen to invoke an action for additional information (such as exact address, hotel contact information, etc.) beyond the hotel price for display on the user terminal.

A web server may include a computer with a processor and storage, together with programming instructions for the purpose of providing content, documents or other data via the Internet. Commonly, functions of a web server (through programming instructions) may be performed on any computer that has Internet access and the physical capabilities. A web server is typically a computer that receives a request for a website page from the user terminal. The web server then, as it has been programmed, returns a document (e.g., a website page) to the terminal and this document is rendered by the user terminal. This document is typically in HyperText Markup Language (HTML) format. However, other similar markup languages or Macromedia Flash may be used. The document may include a website page as an on screen area where viewable maps and hotel room rental rates are loaded for the user. The website page may also include a search box or input area to accept user input such as the geographical area of interest or dates of the hotel stay.

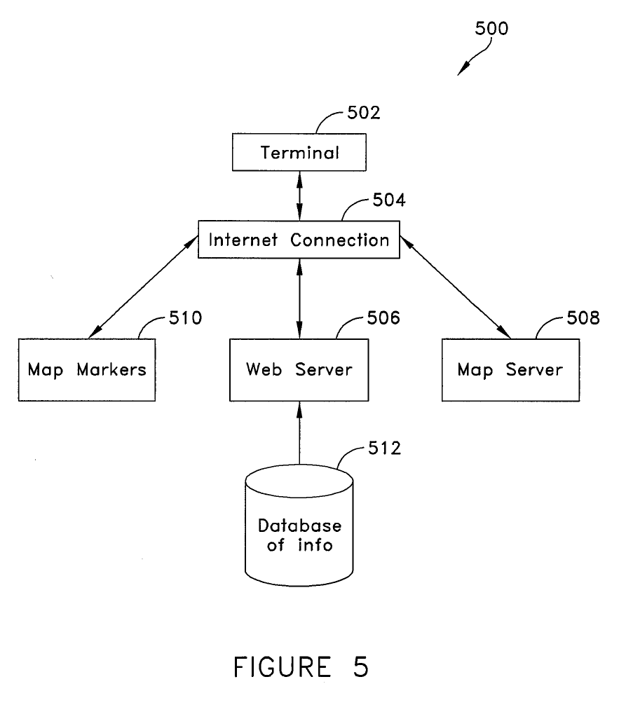

Referring to FIG. 5, and in an embodiment, there is shown an exemplary embodiment of a system 500 for displaying current prices of hotel room rates (or other goods or services) provided at a plurality of locations within a geographical area. A computer terminal 502 may use of an Internet connection 504, either wired or wireless, to communicate with a web server 506, a map server 508 and map markers 510.

User terminal 502 may initially send a request to web server 506 for a web page with web page code to display maps. Web server 506 delivers the web page code back user terminal 502. A web page may have a pre-defined area by the web page code for locating the map on user terminal 502. Through user input, selecting the area of interest, terminal 502 makes a request to map server 508 for a digital map of the particular area of interest. Requests from terminal 502 are made possible through the use of a programming language or technology such as JavaScript, Java, ActiveX, Macromedia Flash, or other similar technology.

In an embodiment, Asynchronous Javascript and XML (AJAX) programming techniques, or other similar interactive programming technologies, may utilize multiple sources of data in real-time to display current prices of goods or services at a plurality of locations within a geographical area. Simply placing generic map markers on a map is not generally difficult. However, interactive programming technologies allow multiple database requests in real-time to constantly update a display on a map of current hotel prices. AJAX type database interactions may be used to combine the current hotel price or other information (e.g., from a database of Information) with an appropriate map marker that depicts such information directly on the map. Through the use of these interactive programming technologies, systems and methods not only identify the location of a hotel on a map, as noted in prior art, but also combine the most currently available hotel room rental rate information with the hotel location information so as to generate or select appropriate map markers to place, and in turn show, hotel information directly on the map. Based on the users selection of an area of interest on the map, the requests for information may be continuously triggered using the interactive programming technologies, and within an instant the most recent hotel room rental rate and location information is retrieved for a plurality of hotels and prepared for incorporation onto the map. The result is a significant improvement in terms of user experience with efficient relay of timely information to the user.

Map server 508 may deliver the requested map to user terminal 502. User terminal 502 makes another request to web server 506 for hotel information in the area generally including, at least, room rental rates and geocode information. To fulfill this request, web server 506 accesses a database of information 512 (which may also be referred to as an information source 512) so as to identify hotels within the boundaries of the map as displayed on user terminal 502. Based on the hotel room rental rate information, web server 506 associates the proper hotel map price markers 510 with the current room rental rate of hotels that are located in the confines of the currently displayed map on the user terminal 502. These markers are delivered using Internet connection 504 to user terminal 502. Map markers 510 are overlaid onto the map by in proper locations using the geocoordinates of each hotel, as retrieved previously from database of information 512, by the user terminal 502.

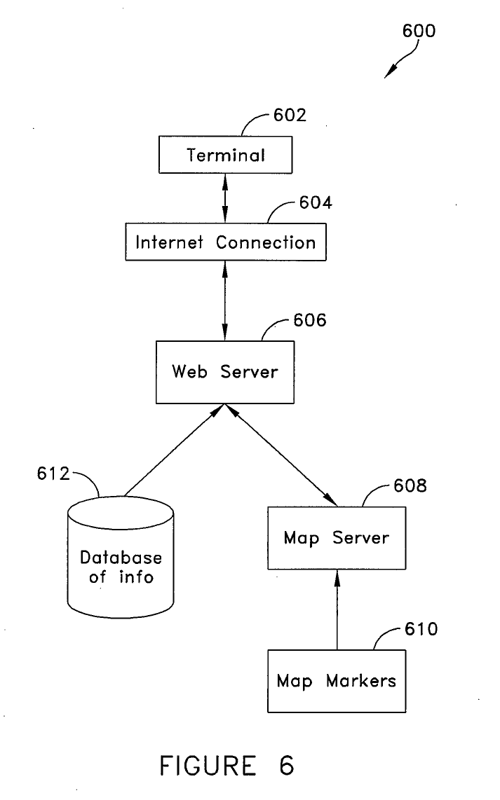

Referring to FIG. 6, and in another embodiment, there is shown an exemplary embodiment of a system 600 for placing pricing information for hotel rental rates directly on a map. Similar to those shown and described with respect to the embodiment of FIG. 5, there may be provided a terminal 602, an Internet connection 604, a web server 606, a map server 608, a set of map markers 610, and a database of information 612. This embodiment differs from the embodiment shown in FIG. 5 in that map markers 610 communicate directly with map server 608. Map markers 610 may be directly incorporated into the actual map image or images instead of overlaid onto the map. The end result is the same hotel room rental rates being displayed directly on the map.

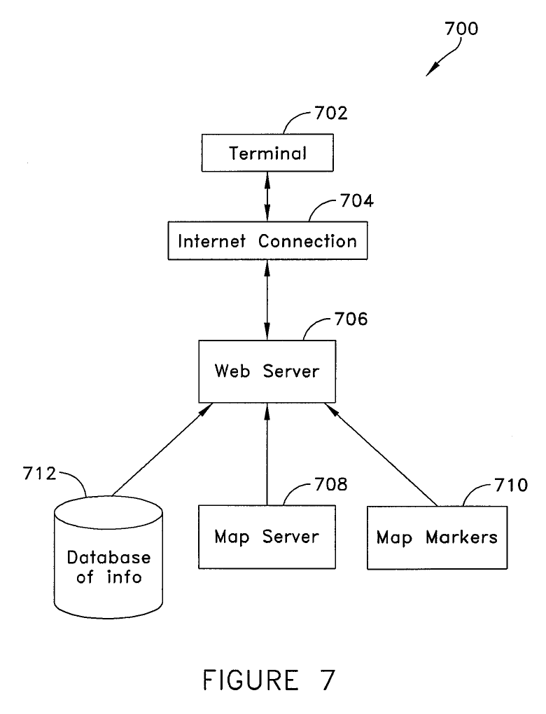

Looking at FIG. 7, and in an embodiment, there is shown an exemplary embodiment of a system 700 for placing pricing information for hotel rates directly on a map. Similar to those shown and described with respect to the embodiments of FIGS. 5 and 6, there may be provided a terminal 702, an Internet connection 704, a web server 706, a map server 708, a set of map markers 710, and a database of information 712. This embodiment differs from the embodiment shown in FIGS. 5 and 6 in that terminal 702 is in direct communication with only the web server 706. Using these connections, maps delivered to the terminal 702 are static and a new web page has to be delivered to terminal 702 each time the user navigates on a map or selects different hotel room criteria.

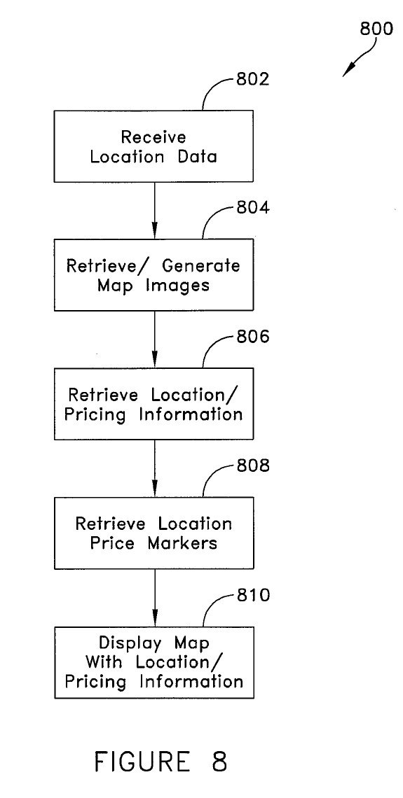

Referring now to FIG. 8, there is shown a flowchart diagram with a method 800 of displaying current prices of hotel rooms (or other goods or services) provided at a plurality of locations within a geographic area. In one embodiment, method 800 may be implemented by system 500 shown in FIG. 5.

Method 800 may include receiving 800 location data. This may be accomplished through a user input with a computer terminal to locate hotel room rental rates for a certain geographic area. The computer terminal user may identify a geographical area of interest by the data input. For example, identifying the area of interest may include entering a city name, state or zip code into a web page search box, using a computer pointing device (such as a computer mouse) to click directly on a specific map area, using the mouse pointer to select a link to specific map location, moving the map using directional arrows, move the map using a mouse dragging technique or the computer terminal could identify an area using Global Positioning System (GPS) information if capability is available. As part of the user input (i.e., requesting location data,) the initial input by the user, may include the dates of the hotel stay, the number of rooms needed, the type of rooms needed and other particular criteria that the user might require of a hotel rental.

Next, method 800 may include retrieving or generating 804 map images. Based on the step of receiving 802 area request, a map of the area of interest may be delivered to the user terminal. For the map server to retrieve or generate the proper maps for the area of interest, the terminal may relay to the map server the geographic boundaries of the display window, and the map server determines the area of the map to return to the user. If sufficient memory resources exist on the terminal, the entire map may be sent from the map server to the user terminal. The digital map may be a single state, city or metropolitan area, or could include the entire United States of America. The digital map may also include any other identifiable geographical area as determined by the user input. Maps may preferably show features such as streets, city names, and other recognizable geographic identifiers.

Method 800 may include receiving 806 location and pricing information. For example, the web server may send a query to the database of information to retrieve the location and pricing information for each hotel that exists in the boundaries of the map. The information retrieved typically includes a variety of details on the hotel in question including, but not limited to, property name, street address, geocode data (latitude and longitude), current room rental prices, the corresponding dates that the rental prices are in effect for, a unique identifier, hotel features and amenities, etc. Other information such as a hotel logo or photographs may also be retrieved from the database of information for a particular hotel.

Method 800 may also include retrieving 808 location price markers. This step may include using the information from the step of receiving 806 location and pricing information. The system matches the hotel room rental rates and hotel information to appropriate map markers to indicate the hotel price at a certain location on the map.

If the map markers have not been pre-generated, the map markers could be generated at the time of the request for a certain map marker. In cases where a hotel may have multiple rooms of different rates available for rent, the system typically displays the lowest room rental rate on the map. In cases where the user has input multiple dates for a hotel stay (i.e., a multiple night stay), the price on the marker may be an average of the available prices at a certain hotel location or the price on the marker may be a sum total of the price (such as a package price).

Method 800 may include displaying 810 a map with location and pricing information. Map markers are relayed to the user terminal where they are overlaid onto the map in the proper geographic locations so that the most current price is displayed directly on the map for each particular hotel. Through further user input, at level of the terminal, if more than one hotel exists in a geographical area of interest, the user has the option and capability of selecting only to view hotel room rental rates for a hotel with a particular brand name, available room types, star level, or certain amenities.

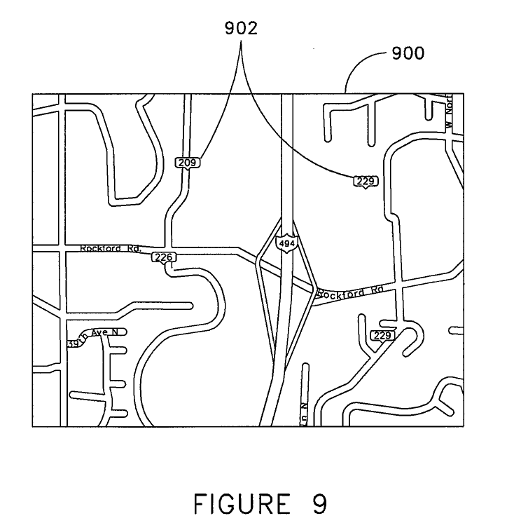

FIG. 9 illustrates an exemplary embodiment of an integrated map 900 as a display in connection with a system for displaying current prices for hotel room rates at a plurality of locations within a geographical area. Dynamic informational price markers 902 are shown on map 900. Markers 902 as shown on the map display the price of a room rental rate at that location. The display of price markers on the digital map gives the user a clear indication of the location and the price of hotel rental rates in the area of interest. This price information is readily apparent to the user without requiring any further user interaction or selection of a particular hotel location. This allows consumers to easily compare hotel room rental rates and locations in order to find the most suitable and economical lodging choice.

The systems and methods described herein may also be used to display other items besides hotels on a map. The systems and methods may be used to display on a map various goods and services in the same manner as hotel prices. These goods and services may include, but are not limited to, gasoline prices or movie ticket prices.

What is claimed is:

1. A system for displaying current prices of selected ones of goods and services provided at a plurality of locations within a geographical area, the system comprising:
a computer terminal for specifying the geographical area containing the plurality of locations, and for displaying a map with the current prices of the selected ones of goods and services provided at the plurality of locations;
a map server for providing a map image including the geographical area containing the plurality of locations specified with the terminal;
an information source for providing data including the current prices of selected ones of goods and services provided at the plurality of locations specified with the computer terminal;
a set of map markers for selected display on the map image provided by the map server, each one of the map markers having at least one alphanumeric character to represent a specific price; and
a web server for relaying the map markers to the computer terminal, and overlaying the map markers onto the map at proper ones of the particular locations so as to display each of the current prices simultaneously on the map for each of the plurality of locations.

2. A system in accordance with claim 1, wherein the selected ones of goods and services are gasoline prices, and wherein the plurality of locations are gasoline stations.

3. A system in accordance with claim 1, wherein the selected ones of goods and services are movie ticket prices, and wherein the plurality of locations are movie theaters.

4. A system in accordance with claim 1, wherein the selected ones of goods and services are hotel room rates, and wherein the plurality of locations are hotels.

5. A system in accordance with claim 1, wherein the current prices are for a future date.

6. A system in accordance with claim 1, wherein the current prices are for a present date.

7. A system in accordance with claim 1, wherein the simultaneous display of each of the current prices on the map for each of the plurality of locations is shown without any user interaction with the map markers.

8. A system in accordance with claim 1, wherein the current prices displayed on the map are shown in a currency including at least one chosen from the group consisting of U.S. dollars, euros, and Canadian dollars.

9. A system in accordance with claim 1, wherein the web server allows at least one additional user input at the terminal when more than one hotel exists in the geographical area, the at least one additional user input allowing display of room rental rates for at least one selected from the group consisting of at least one particular brand-name hotel, at least one available room type, at least one star level, and at least one specified hotel amenity.

10. A system in accordance with claim 1, wherein the web server allows a query to the information source to retrieve the location and pricing information for each of the hotels within the geographical area obtains at least one selected from the group consisting of property name, street address, geocode data, current room rental prices, corresponding dates that the rental prices are in effect, a unique identifier, hotel amenities, a hotel logo, and photographs.

11. A system in accordance with claim 1, wherein the map markers include pre-generated map markers.

12. A system in accordance with claim 1, wherein the map markers include dynamically generated map markers at the time of a request for a certain map marker.

13. A system for displaying current prices of selected ones of goods and services provided at a plurality of locations within a geographical area, the system comprising:
a computer terminal for specifying the geographical area containing the plurality of locations, and for displaying a map with the current prices of the selected ones of goods and services provided at the plurality of locations;
a map server for providing a map image including the geographical area containing the plurality of locations specified with the terminal;
an information source for providing data including the current prices of selected ones of goods and services provided at the plurality of locations specified with the computer terminal;
a set of map markers for selected display on the map image provided by the map server, each one of the map markers having at least one alphanumeric character to represent a specific price; and
a web server for relaying the map markers to the map server, embedding the map markers onto the map at proper ones of the particular locations so as to display each of the current prices simultaneously on the map for each of the plurality of locations, and relaying the map to the user terminal.

14. A system for displaying current prices of selected ones of goods and services provided at a plurality of locations within a geographical area, the system comprising:
a computer terminal for specifying the geographical area containing the plurality of locations, and for displaying a map with the current prices of the selected ones of goods and services provided at the plurality of locations;
a map server for providing a map image including the geographical area containing the plurality of locations specified with the terminal;
an information source for providing data including the current prices of selected ones of goods and services provided at the plurality of locations specified with the computer terminal;
a set of map markers for selected display on the map image provided by the map server, each one of the map markers having at least one alphanumeric character to represent a specific price; and
a web server for relaying the map markers to the web server, overlaying the map markers onto the map at proper ones of the particular locations so as to display each of the current prices simultaneously on the map for each of the plurality of locations, and relaying the map to a computer terminal.

15. A method of displaying current prices of selected ones of goods and services provided at a plurality of locations within a geographic area, the method comprising:
specifying the geographical area by an input of data;
providing a map of the geographical area to a computer terminal based on the input of data;
sending a query to an information source to retrieve location and pricing information for a plurality of the selected ones of goods and services within the geographical area;
matching map markers indicating specific prices to the current prices for each of the selected ones of goods and services using the location and pricing information so as to indicate the current prices at particular locations on the map; and
relaying the map markers to the computer terminal, and overlaying the map markers onto the map at proper ones of the particular locations so as to display each of the current prices simultaneously on the map for each of the plurality of locations.

16. A method in accordance with claim 15, wherein the step of identifying the geographical area of interest by the input of data includes at least one selected from the group consisting of providing a name of a city, providing a name of a state, providing a zip code, using a computer pointing device to click directly on a specific map area, using a mouse pointer to select a link to specific map location, moving the map using directional arrows, moving the map using a mouse dragging technique, and identification of the geographical area using Global Positioning System (GPS) information.

17. A method in accordance with claim 15, wherein the selected ones of goods and services are gasoline prices, and wherein the plurality of locations are gasoline stations.

18. A method in accordance with claim 15, wherein the selected ones of goods and services are movie ticket prices, and wherein the plurality of locations are movie theaters.

19. A method in accordance with claim 15, wherein the selected ones of goods and services are hotel room rates, and wherein the plurality of locations are hotels.

20. A method in accordance with claim 19, wherein the step of specifying the geographical area by the input of data further includes at least one additional user input at the terminal when more than one hotel exists in the geographical area, the at least one additional user input allowing display of room rental rates for at least one selected from the group consisting of at least one particular brand-name hotel, at least one available room type, at least one star level, and at least one specified hotel amenity.

21. A method in accordance with claim 19, wherein the step of specifying the geographical area of interest by the input of data includes at least one selected from the group consisting of dates of stay, number of rooms needed, and type of rooms needed.

22. A method in accordance with claim 19, wherein the step of providing the map of the geographical area to the computer terminal based on the input of data includes providing maps with at least one selected from the group consisting of streets, city names, and geographic identifiers.

23. A method in accordance with claim 19, wherein the step of sending the query to the information source to retrieve the location and pricing information for each of the hotels within the geographical area obtains at least one selected from the group consisting of property name, street address, geocode data, current room rental prices, corresponding dates that the rental prices are in effect, a unique identifier, hotel amenities, a hotel logo, and photographs.

24. A method in accordance with claim 19, wherein the step of matching the map markers and the current prices includes displaying one of the map markers with a lowest room rental rate on the map when a hotel has multiple rooms of different rates available for rent.

25. A method in accordance with claim 19, wherein the step of matching the map markers and the current prices includes displaying one of the map markers with a lowest room rental rate on the map when the user has input multiple dates for a hotel stay

26. A method in accordance with claim 19, wherein the step of matching the map markers and the current prices includes displaying one of the map markets with an average of the available prices at a certain hotel location when the user has input multiple dates for a hotel stay

27. A method in accordance with claim 19, wherein the step of matching the map markers and the current prices includes displaying one of the map markers with a price as a sum total of the price when the user has input multiple dates for a hotel stay

28. A method in accordance with claim 19, wherein the step of relaying the map markers to the user terminal, overlaying the map markers onto the map in the proper geographic locations so as to display each of the current prices simultaneously on the map for each of the plurality of locations includes receiving a user input at the terminal to select to view current prices for at least one chosen from the group consisting of the hotels with a particular brand-name, available room types, star level, and certain amenities.

29. A method in accordance with claim 15 wherein the step of providing the map of the geographical area to the computer terminal based on the input of data includes relaying to a map server the geographic boundaries of a display window in the user terminal, and receiving the map of the geographical area as determined by the map server.

30. A method in accordance with claim 15, wherein the step of providing the map of the geographical area to the computer terminal based on the input of data includes receiving from the map server the map of the geographical area as part of a larger map.

31. A method in accordance with claim 23, wherein the step of receiving from the map server the map of the geographical area as part of the larger map includes one selected from the group consisting of a single state, a city, a metropolitan area, a country, and an identifiable geographical area.

32. A method in accordance with claim 15, wherein the step of matching the map markers and the current prices includes using pre-generated ones of the map markers.

33. A method in accordance with claim 15, wherein the step of matching the map markers and the current prices includes generating the map markers at the time of the request for a certain map marker.

34. A method of displaying current prices of selected ones of goods and services provided at a plurality of locations within a geographic area, the method comprising:
specifying the geographical area by an input of data;
providing a map of the geographical area to a web server based on the input of data;
sending a query to an information source to retrieve location and pricing information for a plurality of the selected ones of the goods and services within the geographical area;
matching map markers indicating specific prices to the current prices for each of the selected ones of goods and services using the location and pricing information so as to indicate the current prices at particular locations on the map; and
relaying the map markers to the map server, embedding the map markers onto the map at proper ones of the particular locations so as to display each of the current prices simultaneously on the map for each of the plurality of locations, and relaying the map to the user terminal.

35. A method of displaying current prices of selected ones of goods and services provided at a plurality of locations within a geographic area, the method comprising:
specifying the geographical area by an input of data;
providing a map of the geographical area to a web server based on the input of data;
sending a query to an information source to retrieve location and pricing information for a plurality of hotels within the geographical area;
matching map markers indicating specific prices to current prices for each of the selected ones of goods and services using the location and pricing information so as to indicate the current prices at particular locations on the map; and
relaying the map markers to the web server, overlaying the map markers onto the map at proper ones of the particular locations so as to display each of the current prices simultaneously on the map for each of the plurality of locations, and relaying the map to a computer terminal.
